(19) United States
(12) Patent Application Publication
(10) Pub. No.: US 2012/0293533 A1
(43) Pub. Date: Nov. 22, 2012

(54) METHODS FOR CREATING GAMMA CORRECTION AND TONE MAPPING EFFECTS IN A DIGITAL IMAGE

(75) Inventor: Rastislav Lukac, Santa Clara, CA (US)

(73) Assignee: Foveon Inc.

(21) Appl. No.: 13/475,935

(22) Filed: May 18, 2012

Related U.S. Application Data
(60) Provisional application No. 61/488,089, filed on May 19, 2011.

(51) Int. Cl. G06T 11/20

(52) U.S. Cl. 345/589

(57) ABSTRACT

A method for creating gamma correction and tone mapping effects in a digital image includes obtaining rendering parameters, generating the rendering curve using the rendering parameters or their subset, and applying the generated rendering curve to the input image.

### RELATED APPLICATIONS

This application claims priority from U.S. Provisional Patent Application Ser. No. 61/488,089, filed May 19, 2011.

### BACKGROUND

1. Field of the Invention

The present invention relates to processing of digital images. More particularly, the present invention relates to methods for creating gamma correction and tone mapping effects in a digital image.

2. The Prior Art

Digital cameras record light using image sensors that usually have a linear response. To produce visually pleasing images, acquired image data have to be passed at some stage (usually at the very end) of the image processing pipeline through a nonlinear process that typically includes gamma correction and tone mapping, and is often termed as rendering. Depending on the application and the user needs, this nonlinear transformation usually aims at producing visually pleasing images with the desired contrast and tonality. It is also possible to aim for a perceptual match between a real scene and the processed image.

The rendering process can be implemented in numerous ways. Typically, gamma correction is performed by applying a power function to the image data. The tonality and contrast of the image is altered using the tone curve, which is usually a smooth nonlinear function to avoid abrupt tonal changes. In digital camera imaging, the tone curve is typically generated using an S-shaped function to produce the desired contrast in midtones. Suitable mathematical models for generating an S-shaped tone curve fall in the category of sigmoidal functions which include, for example, the logistic, arctangent, hyperbolic tangent, error, and various algebraic functions (e.g., x/(1+|x|) and x/(1+x²)^{-1/2}). The two processes, gamma correction and tone-curve rendering, can be combined and implemented using a look-up table. However, different images may require different rendering in order to produce the desired output appearance in terms of some numerical, subjective, or photographic criteria which often refer to image brightness, contrast, shadows and highlights. Therefore, the rendering process should not be performed using the fixed function. To address this problem while allowing to flexibly manipulate with image brightness, contrast, shadows, and highlights in the rendering process, the present invention describes a generalized solution that can generate an optimal rendering curve based on brightness, contrast, shadow and highlight parameters which are either predetermined in the camera or updated based on image statistics or through the user interface.

### BRIEF DESCRIPTION

According to a first aspect of the present invention, a method for performing gamma correction and tone mapping effects in a digital image includes obtaining rendering parameters, generating the rendering curve using the rendering parameters or their subset, and applying the generated rendering curve to the input image.

According to another aspect of the present invention a method for performing gamma correction and tone mapping effects in a digital image includes obtaining rendering parameters, obtaining adjustment parameters, combining the rendering and adjustment parameters to obtain the final rendering parameters, generating the rendering curve using the final rendering parameters or their subset, and applying the generated rendering curve to the input image.

According to another aspect of the present invention a method for performing gamma correction and tone mapping effects in a digital image includes defining the input vector as a set of integers ranging from zero to some desired image brightness parameter value, normalizing the input vector between zero and one, applying a power function with a proper gamma to the normalized input vector, applying a nonlinear smooth function shaped by some desired contrast, shadows, and highlights parameter values, rescaling the vector range between zero and maximum allowed output value, rounding the rescaled vector to produce the final rendering look-up table, and applying the table to the input image.

According to another aspect of the present invention a method for performing gamma correction and tone mapping effects in a digital image includes dividing an input range into segments, defining an input vector for each segment, normalizing each input vector, applying a power function with proper gamma to each normalized input vector, applying a nonlinear smooth function shaped by obtained contrast shadows and highlights parameter values, re-scaling vector range between zero and maximum allowed value, rounding the re-scaled vector to produce final rendering lookup table, combining segment outputs, and applying the generated rendering table to input image.

### BRIEF DESCRIPTION OF THE DRAWING FIGURES

FIG. 1 is a flow diagram showing an illustrative method for performing gamma correction and tone mapping effects in a digital image according to the present invention.

FIG. 2 is a flow diagram showing another illustrative method for performing gamma correction and tone mapping effects in a digital image according to the present invention.

FIG. 3 is a flow diagram showing another illustrative method for performing gamma correction and tone mapping effects in a digital image according to the present invention.

FIG. 4 is a flow diagram showing another illustrative method for performing gamma correction and tone mapping effects in a digital image according to the present invention.

FIG. 5 is a flow diagram showing an illustrative method for performing gamma correction and tone mapping effects in a digital color image according to the present invention.

FIG. 6 is a flow diagram showing another illustrative method for performing gamma correction and tone mapping effects in a digital color image according to the present invention.

### DETAILED DESCRIPTION

Persons of ordinary skill in the art will realize that the following description of the present invention is illustrative only and not in any way limiting. Other embodiments of the invention will readily suggest themselves to such skilled persons.

The present invention relates to methods for creating gamma correction and tone mapping effects in a digital image. This invention is not limited to the specific examples presented below.

In photographic applications, the final image appearance greatly depends on brightness, contrast, shadow and highlight characteristics. Therefore, the rendering method of the present invention is a function (combined power/sigmoidal function) of brightness or exposure setting B, contrast setting C, shadow setting S, and highlight setting H. This generalized solution can generate an optimal rendering curve using these parameters, referred herein as the rendering parameters, which primarily denote the shape of the nonlinear transformation function applied to the input image.

In one example, the rendering transformation is expressed as a function shaped by these four rendering parameters B,C,S,H or their subsets. Such implementation can be useful for in-camera image processing which is usually fully automatic. The default rendering parameters are obtained (e.g., in the camera calibration phase) based on the evaluation of a number of test images.

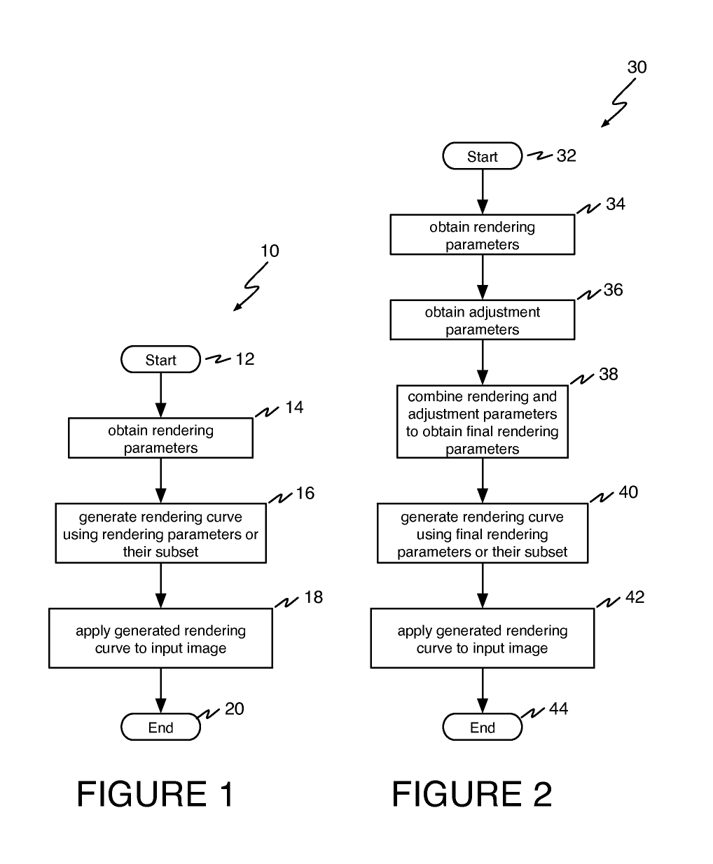

Referring first to FIG. 1, a flow diagram shows an illustrative method 10 for performing gamma correction and tone mapping effects in a digital image according to the present invention. The process begins at reference numeral 12.

At reference numeral 14, rendering parameters are obtained. At reference numeral 16, the rendering curve (represented as a table or in other suitable form characterizing desired input-to-output mapping) is generated using the rendering parameters or their subset. At reference numeral 18, the generated rendering curve is applied to the input image. The process ends at reference numeral 20.

In another example, the rendering transformation is expressed as a function shaped by the rendering parameters B,C,S,H and the adjustment parameters referred herein as α_{B} for brightness or exposure control, α_{C} for contrast control, α_{S} for shadow control, and α_{H} for highlight control. Such implementation is useful in applications where the user controls the rendering process through some interface or the main rendering parameters (i.e., B,C,S,H) need to be automatically adjusted based on image statistics. In yet another example, the rendering transformation is expressed as a function shaped by a subset of the four parameter pairs {B, α_{B}}, {C, α_{C}}, {S, α_{S}}, and {H, α_{H}}.

The actual adjustment of rendering transformation is obtained by combining B with α_{B}, C with α_{C}, S with α_{S}, and H with α_{H} to produce final rendering values B′, C′, S′, and H′. The combination may be made in a number of different ways according to the present invention.

Referring now to FIG. 2, a flow diagram shows another illustrative method 30 for performing gamma correction and tone mapping effects in a digital image according to the present invention. The process begins at reference numeral 32.

At reference numeral 34, rendering parameters are obtained. At reference numeral 36, adjustment parameters are obtained. At reference numeral 38, the rendering and adjustment parameters are combined to obtain the final rendering parameters. At reference numeral 40, the rendering curve (represented as a table or in other suitable form characterizing desired input-to-output mapping) is generated using the final rendering parameters or their subset. At reference numeral 42, the generated rendering curve is applied to the input image. The process ends at reference numeral 44.

In one illustrative example, the adjustment parameters are simply added to the rendering parameters. In this case, the neutral value (for which no adjustment will be produced) of α_{B}, α_{C}, α_{S}, α_{H} is zero. In another illustrative example, the adjustment parameters are multiplied with the corresponding rendering parameters; in this case the neutral value of α_{B}, α_{C}, α_{S}, α_{H} is one. In yet another example, the rendering parameters are multiplied with a function of the corresponding adjustment parameter. An example of such function is 2^{α} where α is one of α_{B}, α_{C}, α_{S}, α_{H}; in this case the neutral value of α_{B}, α_{C}, α_{S}, α_{H} is zero. In yet another example, the rendering parameters are added to the value obtained as a function of the corresponding adjustment parameter. Each of these adjustment parameters can vary in some predetermined range. Depending on the function used for adjustment and the particular implementation (e.g., addition, multiplication, or 2^{α}), the parameter range and the neutral value (set usually in the middle of the range) of adjustment parameters will vary. In one example, the user can select the values of adjustment parameters to be anything in the allowed range through some interface. In another example, the default values of adjustment parameters are predetermined. In yet another example, the values of adjustment parameters are calculated/updated based on the actual image statistics. If the value of any adjustment parameter calculated/updated based on the actual image statistics is below its minimum allowed value or exceeds its maximum allowed value, it may be replaced with the minimum or the maximum allowed value, respectively.

Once the final rendering parameters (i.e., B′, C′, S′, and H′) have been determined (note that B′=B, C′=C, S′=S, and H′=H if the corresponding adjustment parameters α_{B}, α_{C}, α_{S}, and α_{H} are set to their neutral values), depending on the actual implementation, the input image can be directly passed through the rendering process, or it may require one or more processing operations, such as rounding to the integer values and/or clipping the image (for instance, setting negative values to zero, and large values to a predetermined maximum value) prior to performing the rendering process.

According to one aspect of the rendering method of the present invention, the range of input pixel values in which the combined gamma correction and tone mapping should be performed can be specified. This range can be represented as a vector x ranged from 0 to B, or 0 to max(B′,ξ), or 0 to min(B′,ξ), where ξ denotes the maximum value in a given numerical representation (e.g., 4095 in a 12-bit integer representation) or alternatively τ represents some predetermined value. An arbitrary function which meets the criteria for rendered image appearance can be used to transform the vector of input values to the corresponding output value.

The vector x can be normalized between zero and one by dividing x with the maximum sample in x, the result further subject to a power function controlled by a γparameter which characterizes the output space (e.g., γ=0.45 for sRGB color space or γ=1.0 if the input image has already been subject to gamma correction). Formally, this operation produces a gamma corrected vector z with samples zᵢ₊ₗ=(xᵢ₊₁/max(x))^{γ}, for i=0,1,2, . . . ,max(x). Alternatively, the vector x can be normalized using at least one predetermined value. Then, each zᵢ₊ₗ value is updated using final contrast, shadow, and highlight rendering parameters C′, S′, and H′.

In the example implementation, z′ᵢ₊ₗ=1/(1+exp(−C(S′+(H′−S′)zᵢ₊ₗ))). Then, each updated value is normalized between zero and one, to be further multiplied with the maximum allowable value V in a given output space (e.g., V=255 for 8-bit sRGB) to produce the output value. In one example implementation, this can be done as z″ᵢ₊ₗ=(z′ᵢ₊ₗ−z′₁) followed by oᵢ₊ₗ=V(z″ᵢ₊ₗ/max(z″)) where z″ is a set of all z″ᵢ₊ₗ values. The set of all oᵢ₊ₗ values represents the output vector o. In another example implementation, the normalization process can be done as z″ᵢ₊₁=(z′ᵢ₊₁−z′_{ε}) where ε is predetermined in the calibration or adaptive determined using the image statistics; this step is followed by the rescaling defined as oᵢ₊ₗ=V(z″ᵢ₊ₗ/max(z″)) where z″ is a set of all z″ᵢ₊₁ values.

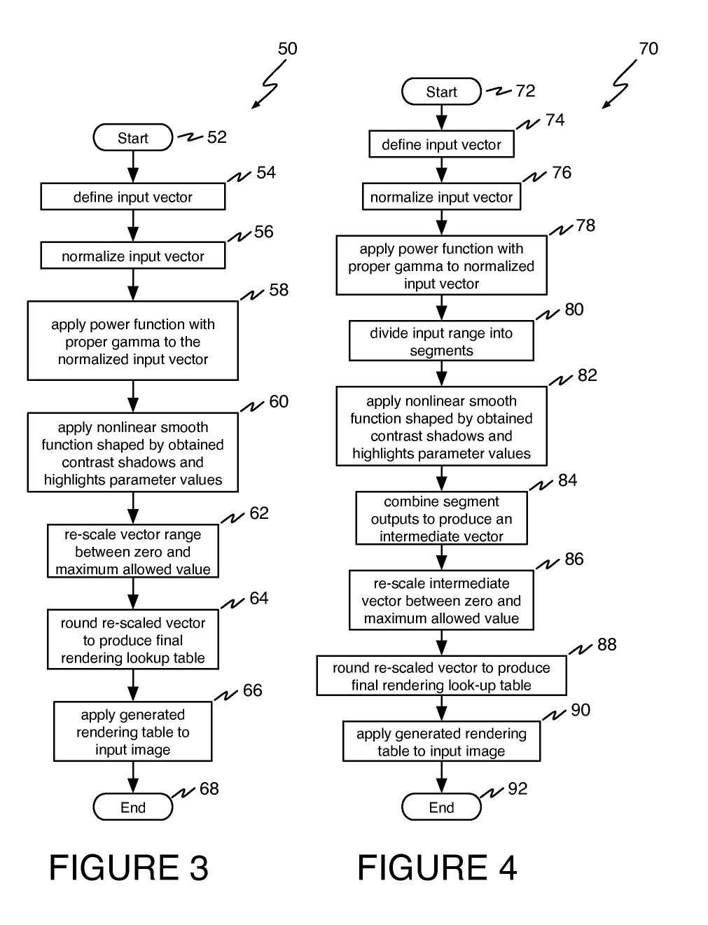

Referring now to FIG. 3, a flow diagram shows an illustrative vector-based method 50 for performing gamma correction and tone mapping effects in a digital image according to the present invention. The process begins at reference numeral 52.

At reference numeral 54, an input vector is defined. At reference numeral 56, the input vector is normalized. At reference numeral 58, a power function with a proper gamma is applied to the normalized input vector. At reference numeral 60, a nonlinear smooth function shaped by obtained contrast, shadows, and highlights parameter values is applied. At reference numeral 62, the vector range is re-scaled between zero and maximum allowed output value. At reference numeral 64, the rescaled vector is rounded to produce the final rendering look-up table. At reference numeral 66, the lookup table is applied to the input image. The process ends at reference numeral 68.

In yet another example, the range of input values, denoted by x, can be divided into two or more segments, each being represented by their own rendering parameters or their subset. The final rendering transformation function is obtained by combining the outputs obtained for each segment. In the example implementation, z′(j) represents the vector of z′ᵢ₊ₗ values obtained in the jth segment, these values being updated as z′(j)=z′(j)+max(z′(j−1))−min(z′(j)), for j=2,3, . . . ,N where N denotes the number of segments. Once all z′ᵢ₊₁ values have been updated, the procedure continues by calculating z″ᵢ₊ₗ values to produce the final oᵢ₊ₗ values.

Once the output vector o has been calculated, the rendering transform can be applied by simply replacing the pixel value α with the corresponding output value o_{α+1}. Since the vector o of output values is calculated only once, the approach is computationally very efficient, particularly when it comes to large images. Persons of ordinary skill in the art will appreciate that the output rendered value can also be directly calculated in each pixel location from the input pixel value; this approach does not require neither storing the rendering curve/look-up table nor performing the rounding in the rendering process.

Referring now to FIG. 4, a flow diagram shows an illustrative vector-based method 70 for performing gamma correction and tone mapping effects in a digital image according to the present invention. The process begins at reference numeral 72.

At reference numeral 74, an input vector is defined. At reference numeral 76, the input vector is normalized. At reference numeral 78, a power function with a proper gamma is applied to the normalized input vector. At reference numeral 80, a normalized range is divided into segments. Persons of ordinary skill in the art will appreciate that the input range may be divided into segments at the beginning of the process.

At reference numeral 82, a nonlinear smooth function shaped by obtained contrast shadows and highlights parameter values is applied to each segment. At reference numeral 84, the segment outputs are combined to produce an intermediate vector. At reference numeral 86, the intermediate vector is re-scaled between zero and maximum allowed value. At reference numeral 88, the rescaled vector is rounded to produce the final rendering look-up table. At reference numeral 90, the generated rendering table is applied to the input image. The process ends at reference numeral 92.

According to one aspect of the rendering method of the present invention, the rendering curve (represented as a table or in other suitable form characterizing desired input-to-output mapping) is applied directly to the input image. In the case of color images, each color channel is processed independently.

According to another aspect of the present invention, the rendering curve is only applied to the luminance components of the input color image. The luminance components can be obtained as a combination (e.g., average or weighted average) of red, green, and blue components in each pixel location or alternatively a predetermined color channel (e.g., green) can be used to represent the luminance. Then, in each pixel location, the respective red, green, and blue color components are scaled using the ratio of rendered luminance component and the original luminance component.

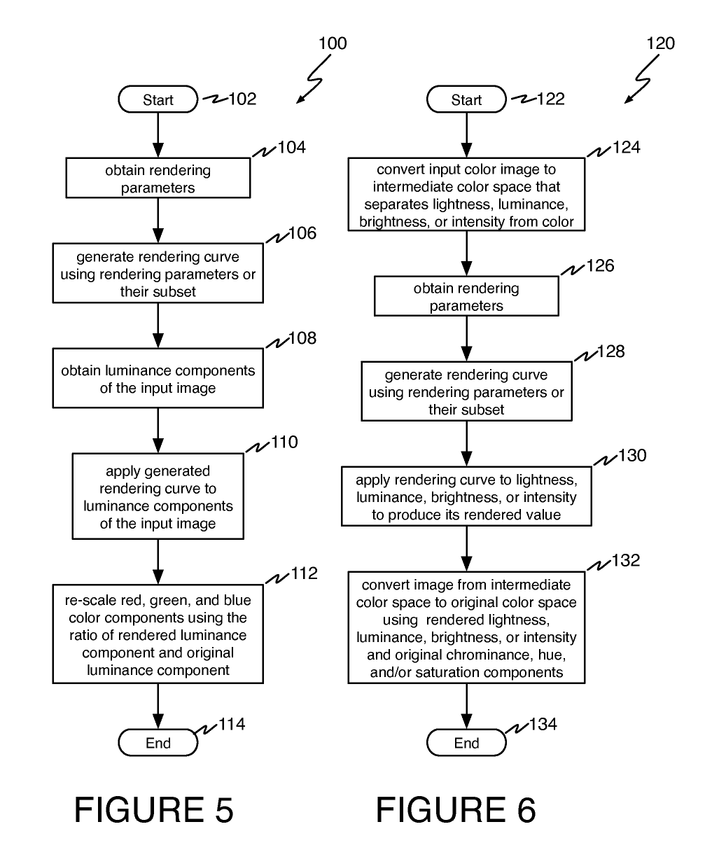

Referring now to FIG. 5, a flow diagram shows an illustrative method 100 for performing gamma correction and tone mapping effects in a digital image according to the present invention. The process begins at reference numeral 102.

At reference numeral 104, rendering parameters are obtained. At reference numeral 106, the rendering curve (represented as a table or in other suitable form characterizing desired input-to-output mapping) is generated using the rendering parameters or their subset. At reference numeral 108, the luminance components of the input image are obtained. At reference numeral 110, the generated rendering curve is applied to the luminance components of the input image. At reference numeral 112, rescale red, green, and blue color components using the ratio of rendered luminance component and the original luminance component. The process ends at reference numeral 114.

According to another aspect of the present invention, the input color image is first converted to some predetermined intermediate color space (e.g., Lab, Luv, YUV, YCbCr, HSV, HSI) which separates the lightness, luminance, brightness, or intensity component (e.g., L, Y, V, or I) from the color pixel. Then, the rendering curve (represented as a table or in other suitable form characterizing desired input-to-output mapping) is generated for and applied to the extracted lightness, luminance, brightness, or intensity component to produce its rendered version. In the final step, the rendered lightness, luminance, brightness, or intensity and the original chrominance (e.g., a and b, u and v, U and V, Cb and Cr), hue (H), and/or saturation (S) components are used to perform a conversion from the intermediate color space to the original color space.

Referring now to FIG. 6, a flow diagram shows an illustrative method 120 for performing gamma correction and tone mapping effects in a color digital image according to the present invention. The process begins at reference numeral 122.

At reference numeral 124, the input color image is converted to intermediate color space that separates the lightness, luminance, brightness, or intensity component from each color pixel. At reference numeral 126, rendering parameters are obtained. At reference numeral 128, a rendering curve (represented as a table or in other suitable form characterizing desired input-to-output mapping) is generated using the rendering parameters or their subset. At reference numeral 130, the rendering curve is applied to the lightness, luminance, brightness, or intensity to produce its rendered value. At reference numeral 132, the image is converted from the intermediate color space to the original color space using the rendered lightness, luminance, brightness, or intensity and the original chrominance, hue, and/or saturation components. The process ends at reference numeral 134.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. Inventive aspects lie in less than all features of a single foregoing disclosed embodiment, and each embodiment described herein may contain more than one inventive feature.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for creating gamma correction and tone mapping effects in a digital image comprising:
obtaining rendering parameters;
generating the rendering curve using the rendering parameters or their subset; and
applying the generated rendering curve to the input image.

2. The method of claim 1 wherein:
the image is a color image; and
applying the generated rendering curve comprises obtaining a luminance, applying the rendering curve to the luminance, and scaling, in each pixel location, the respective red, green, and blue color components using the ratio of rendered luminance component and the original luminance component.

3. The method of claim 2 wherein the rendered luminance is obtained as a combination of red, green, and blue components in each pixel location.

4. The method of claim 3 wherein the combination of red, green, and blue components in each pixel location is one of an average and a weighted average.

5. The method of claim 3 wherein the luminance is represented by a predetermined color channel.

6. A method for creating gamma correction and tone mapping effects in a digital image comprising:
obtaining rendering parameters;
obtaining adjustment parameters,
combining the rendering and adjustment parameters to obtain the final rendering parameters;
generating the rendering curve using the final rendering parameters or their subset; and
applying the generated rendering curve to the input image.

7. The method of claim 6 wherein obtaining adjustment parameters includes obtaining default values.

8. The method of claim 6 wherein obtaining adjustment parameters includes obtaining values from a user interface of a digital camera.

9. The method of claim 6 wherein obtaining adjustment parameters includes obtaining values calculated based on actual image statistics.

10. The method of claim 1 wherein the rendering curve is represented in a form characterizing desired input-to-output mapping.

11. The method of claim 10 wherein the rendering curve is represented as a table.

12. A method for creating gamma correction and tone mapping effects in a digital image comprising:
defining an input vector as a vector ranging from ranging from zero to obtained image brightness parameter value;
normalizing the input vector;
applying a power function with a proper gamma to the normalized input vector;
applying a nonlinear smooth function shaped by obtained contrast, shadows, and highlights parameter values;
rescaling the vector range between zero and maximum allowed output value;
rounding the rescaled vector to produce the final rendering curve; and
applying the rendering curve to the input image.

13. The method of claim 12 wherein the rendering curve is a look-up table.

14. The method of claim 12 wherein normalizing the input vector comprises normalizing the input vector to a value between zero and one.

15. The method of claim 12 wherein:
the rendering curve is represented as a table or in other form characterizing desired input-to-output mapping; and
the rendering curve is applied directly to the input image.

16. The method of claim 12 wherein:
the digital image is a color image having a plurality of color channels; and
each color channel is processed independently.

17. A method for creating gamma correction and tone mapping effects in a digital image comprising:
defining an input vector;
normalizing each input vector;
applying a power function with proper gamma to each normalized input vector;
dividing the input range into segments;
applying a nonlinear smooth function shaped by obtained contrast shadows and highlights parameter values;
combining segment outputs to produce an output vector;
re-scaling the output vector range between zero and maximum allowed value;
rounding the re-scaled vector to produce final rendering curve; and
applying the generated rendering curve to input image.

18. A method for creating gamma correction and tone mapping effects in a color digital image comprising:
converting the input color image from an original color space to a predetermined intermediate color space which separates the lightness, luminance, brightness, or intensity component from color;
generating a rendering curve for the extracted lightness, luminance, brightness, or intensity;
applying the rendering curve to the extracted lightness, luminance, brightness, or intensity to produce its rendered version;
performing a conversion from the intermediate color space to the original color space using the rendered lightness, luminance, brightness, or intensity and at least one of the original chrominance, hue, and saturation components.

19. The method of claim 18 wherein the rendering curve is represented in a form characterizing desired input-to-output mapping.

20. The method of claim 19 wherein the rendering curve is represented as a table.
